(19) United States
(12) Patent Application Publication
(10) Pub. No.: US 2018/0240018 A1
(43) Pub. Date: Aug. 23, 2018

(54) IMPROVED EXTREME LEARNING MACHINE METHOD BASED ON ARTIFICIAL BEE COLONY OPTIMIZATION

(71) Applicant: Jiangnan University, Wuxi (CN)

(72) Inventors: Li MAO, Wuxi (CN); Yu MAO, Wuxi (CN); Yongsong XIAO, Wuxi (CN)

(73) Assignee: Jiangnan University, Wuxi (CN)

(21) Appl. No.: 15/550,361

(22) PCT Filed: May 19, 2016
(86) PCT No.: PCT/CN2016/082668

§ 371 Date: Aug. 10, 2017

(51) Int. Cl. G06N 3/08; G06N 3/00

(52) U.S. Cl. CPC G06N 3/086; G06N 3/008

(57) ABSTRACT

The present invention discloses an improved extreme learning machine method based on artificial bee colony optimization, which includes the following steps: Step 1, generating an initial solution for SN individuals: Step 2, globally optimizing a connection weight ω and a threshold b for the extreme learning machine; Step 3, locally optimizing the connection weight ω and threshold b of the extreme learning machine; Step 4, if food source information is not updated within a certain time, transforming employed bees into scout bees, and reinitializing the individuals after returning to Step 1; and Step 5, extracting the connection weight ω and threshold b of the extreme learning machine from the best individuals, and verifying by using a test set. With the method provided by the present invention, the defect of worse results of the traditional extreme learning machine in classification and regression is overcomed, and effectively improves the results of classification and regression.

### FIELD OF THE INVENTION

The present invention belongs to the technical field of artificial intelligence and relates to an improved extreme learning machine method, and in particular, to an improved extreme learning machine method base on artificial bee colony optimization.

### BACKGROUND OF THE INVENTION

Artificial neural networks (ANN) are algorithm-oriented mathematical models for simulating the behavior characteristics of biological neural networks for distributed parallel calculation processing. Therein, single-hidden layer feed forward neutral networks (SLFN) have been extensively applied to many fields due to their good learning ability. However, the values of hidden nodes are corrected with a gradient descent method in most of the traditional feed forward neutral networks, therefore, disadvantages such as slow training speed, easy coverage to local minima, and requirements for setting more parameters may easily occur. In recent years, a new feed forward neutral network, i.e. extreme learning machine (ELM), has been proposed by Huang et al., (Huang G B, Zhu Q Y, Siew C K. Extreme learning machine: theory and applications. Neurocomputing, 2006, 70(1-3): 489-501). Since the extreme learning machine can randomly generate unchanged connection weights between an input layer and a hidden layer as well as a hidden layer neuron threshold b before training, some defects of the traditional feed forward neural networks can be overcome. With faster learning speed and excellent generalization performance, the extreme learning machine has been researched by and attracted the attentions of many scholars and experts at home and abroad. With broad applicability, the extreme learning machine is not only applicable to the issues of regression and fitting, but also applicable to the fields such as classification and mode recognition, and thus has been applied extensively.

As the connection weight and threshold b of the extreme learning machine are generated randomly before training and keep unchanged during the training, part of hidden nodes have a very little effect only, and the consequence that most of the nodes approach 0 may be even caused if there is a bias in a data set. Therefore, Huang et al., point that a large amount of hidden nodes need to be set in order to achieve ideal accuracy.

To overcome this defect, some scholars have achieved a good effect by using an intelligent optimization algorithm in combination with the extreme learning machine. An evolutionary extreme learning machine (E-ELM) is proposed by Zhu et al., (Zhu Q Y, Qin A K, Suganthan P N, et al. Evolutionary extreme learning machine[J]. Pattern recognition, 2005, 38(10): 1759-1763.), where a differential evolutionary algorithm is used to optimize the parameters of hidden nodes of ELM to thereby improve the performance of ELM, but with more parameters required to be set and complex experimental process; a self-adaptive evolutionary extreme learning machine (SaE-ELM) is proposed by Cao et al., (Cao J, Lin Z, Huang G B. Self-adaptive evolutionary ex-treme learning machine[J]. Neural processing letters, 2012, 36(3): 285-305.), where a self-adaptive evolutionary algorithm and the extreme learning machine are combined to optimize the hidden nodes, with fewer parameters set, which improves the accuracy and stability of the extreme learning machine regarding the issues of regression and classification, however, this algorithm has the defects of overlong used time and worse practicability; an extreme learning machine based on particle swarm optimization (PSO-ELM) is proposed by Wang Jie et al., (Wang Jie, Bi Haoyang. Extreme learning machine based on particle swarm optimization [J]. Journal of Zhengzhou University (Natural Science Edition), 2013, 45(1): 100-104.), where a particle swarm optimization algorithm is used to optimize and choose the input layer weight and hidden layer bias of the extreme learning machine to obtain an optimal network, however, this algorithm only achieves a better result in function fitting but has worse effect during practical application; and a novel hybrid intelligent optimization algorithm (DEPSO-ELM) based on a differential evolution algorithm and a particle swarm optimization algorithm is proposed by Lin Meijin et al., (Lin Meijin, Luo Fei, Su Caihong et. al. A novel hybrid intelligent extreme learning machine [J]. Control and Decision, 2015, 30(06): 1078-1084.) with reference to the memetic evolution mechanism of a frog-leaping algorithm for parameter optimization, where the extreme learning machine algorithm is used to solve an output weight of SLFNs, but with excessive dependency on experimental data and worse robustness.

Therefore, how to overcome the defects in the traditional extreme learning machine in a better way and improve the effect thereof appears to be very important.

A traditional extreme learning machine regression method is as follows:

for N arbitrary distinct different training sample sets (xᵢ,yᵢ) (i=1, 2, . . . , N), xᵢ∈R^{d}, yᵢ∈R^{m}, one feed forward neural network having L hidden nodes has an output as follow:

$${t}_{i} = {\sum }_{j = 1}^{L} {β}_{j} g ( {ω}_{j} - {x}_{i} + {b}_{j} ) , i = 1 , 2 , … , N \qquad ( 1 )$$

In Formula (1), ωⱼ∈R^{d} is a connection weight from an input layer to a hidden node, bⱼ∈R is a neural threshold of the hidden node, g( ) is an activation function of the hidden node, g(ωⱼ−xᵢ+bⱼ) is an output of the i^{th} sample at the hidden node, ωⱼ·xᵢ is an inner product of a vector, and βⱼ is a connection weight between the hidden node and an output layer.

Step 1a, randomly initialize the connection weight and threshold b, which are randomly chosen when network training begins and keep unchanged in a training process;

Step 2a, solve a least square solution of a linear equation below to obtain an output weight \hat{β}:

$$min {\sum }_{i = 1}^{N} ‖ {y}_{i} - {t}_{i} ‖ = 0 \qquad ( 2 )$$

the solution of Equation (2) is as follows:

\hat{β}=H⁺T (3)

In Formula (3), H⁺ stands for a Moore-Penrose (MP) generalized inverse of a hidden layer output matrix.

Step 3a, substitute \hat{β} solved in Formula (3) into Formula (1) to possibly obtain a calculation result.

The traditional artificial bee colony (ABC) optimization algorithm has the following steps:

Step 1b, generation of an initial solution, where an initial solution is generated for SN individuals at an initialization phase, with a formula as follows:

$${x}_{i , j} = {x}_{j}^{m i n} + rand [ 0 , 1 ] ( {x}_{j}^{ma x} - {x}_{j}^{m i n} ) \qquad ( 4 )$$

In Formula (4), i∈{1, 2, . . . , N} indicates the number of the initial solution, j=1, 2, . . . , D indicates that each initial solution is a D-dimensional vector, rand [0,1] indicates that a random number ranging from 0 to 1 is chosen, xⱼ^{max} and xⱼ^{min} indicate an upper bound and a lower bound of the j^{th} dimension of the solution, respectively.

Step 2b, searching phase of employed bees, where each employed bee individual searches a new nectar source nearby a current position from an initial position, with an updating formula as follows:

v_{i,j}=x_{i,j}=rand[−1,1](x_{i,j}−x_{k,j}) (5)

In Formula (5), v_{i, j} indicates position information of a new nectar source, x_{i, j} indicates position information of an original nectar source, rand [−1, 1] indicates that a random number ranging from −1 to 1 is chosen, and x_{k, j} indicates the j^{th} dimension information of the k^{th} nectar source, k∈{1, 2, . . . , SN}, with k≠i.

A fitness value of the nectar source would be calculated when the employed bees acquire the position information of the new nectar source, and the position of the new nectar source is employed if the fitness of the new nectar source is better than that of the original nectar source. Or else, the position information of the original nectar source is used continuously, with a collecting number increased by 1.

Step 3b, onlooking phase of onlooker bees, where the onlooker bees choose the information of the nectar source with higher fitness based on probability according to the position information transmitted by the employed bees, a changed position is generated based on the employed bees and the new nectar source is searched. The choice probability calculation formula is as follows:

$${P}_{i} = fitness ( {x}_{i} ) / {\sum }_{j = 1}^{SN} fitness ( {x}_{j} ) \qquad ( 6 )$$

In Formula (6), fitness (xᵢ) indicates the fitness value of the i^{th} onlooker bee. Pᵢ indicates the probability of choosing the i^{th} onlooker bee. Once the onlooker bee is chosen, an position updating operation is performed according to Formula (5). The new nectar source is used if it is better in fitness, or else, the position information of the original nectar information is used continuously, with the collecting number increased by 1.

Step 4b, searching phase of scout bees, where when the nectar source is collected to a certain number of times but remains unchanged in fitness value, the employed bees transform into scout bees and search for a new nectar source position, with a searching formula the same as Formula (4).

### SUMMARY OF THE INVENTION

With respect to the defects occurring when the traditional extreme learning machine is applied to classification and regression, the present invention proposes an improved extreme learning machine method based on artificial bee colony optimization (DECABC-ELM) in view of the traditional extreme learning machine, which effectively increases the effects of classification and regression.

The technical solution of the present invention is as follows:

an improved extreme learning machine method based on artificial bee colony optimization comprises the following steps:

given a training sample set (xᵢ,yᵢ) (i=1, 2, . . . , N), xᵢ∈R^{d}, yᵢ∈R^{m}, with an activation function of g( ), and the number of hidden nodes of L;

Step 1, generating an initial solution for SN individuals as follows:

x_{i,j}=xⱼ^{min}+rand[0,1](xⱼ^{max}−xⱼ^{min}), (7)

wherein each individual is encoded in a manner as shown below:

θ_{G}=[ω_{l,G}^{T}, . . . ,ω_{L,G}^{T},b_{l,G}, . . . ,b_{L,G}];

and during encoding, ωj(j=1, . . . , L) is a D-dimensional vector, with each dimension being a random number ranging from −1 to 1, bⱼ is a random number ranging from 0 to 1, and G indicates an iteration number for a bee colony;

Step 2, globally optimizing a connection weight ω and a threshold b for an extreme learning machine as follows:

v_{i,j}=x_{ĩ,j}+rand[−1,1](x_{best,j}−x_{k,j}+x_{l,j}−x_{m,j}), (8)

wherein in formula (8), x_{best, j} stands for a currently best individual in the bee colony, x_{k, j}, x_{l, j} and x_{m, j} are another three different individuals chosen randomly other than the current individual, i.e, i≠k≠l≠m; whenever employed bees reach a new position, a training sample set is verified by means of the connection weight ω and threshold b of the extreme learning machine and a fitness value is obtained, and if the fitness value is higher, new position information is used to substitute old position information;

Step 3, locally optimizing the connection weight ω and threshold b of the extreme learning machine;

first, an onlooker bee is cloned according to fitness thereof, which is in direct proportion to a cloning number as follows:

$${N}_{i} = int [ SN \times fitness ( {x}_{i} ) / {\sum }_{i = 1}^{SN} fitness ( {x}_{i} ) ] , \qquad ( 9 )$$

wherein in formula (9), Nᵢ indicates the cloning number of the i^{th} onlooker bee, SN indicates the total number of the individuals, and fitness(xᵢ) indicates a fitness value of the i^{th} following bee;

second, for a clonally increased colony, the onlooker bees with a choice probability being more than a random number ranging from 0 to 1 are optimized according to a fitness probability calculation formula in the same optimization manner as that in Formula (8);

after the position information of the onlooker bees is changed, a food source is chosen with a choice probability calculation formula by means of a concentration probability and the fitness probability of the colony and new position information is created; and the new position information is the same as the position information before expansion in number;

the fitness probability calculation formula is as follows:

$${P}_{i} = fitness ( {x}_{i} ) \text{/} {\sum }_{j = 1}^{SN} fitness ( {x}_{j} ) , \qquad ( 6 )$$

a concentration probability calculation formula is as follows:

$$\{ \begin{matrix}{P}_{d} ( {x}_{i} ) = \frac{1}{SN} ( 1 - \frac{HN}{SN} ) & if \frac{{N}_{i}}{SN} > T \\ {P}_{d} ( {x}_{i} ) = \frac{1}{SN} ( 1 + \frac{HN}{SN} \times \frac{HN}{SN - HN} ) & if \frac{{N}_{i}}{SN} \leq T\end{matrix} , \qquad ( 10 )$$

wherein in Formula (10), Nᵢ indicates the number of onlooker bees having a fitness value approximate to the i^{th} onlooker bee,

$$\frac{{N}_{i}}{SN}$$

indicates a quantitative proportion of these onlooker bees approximate in fitness in the colony, T is a concentration threshold, and HN indicates the number of onlooker bees having the concentration of more than T;

the choice probability calculation formula is as follows:

P_{choose}(xᵢ)=αPᵢ(xᵢ)+(1−α)P_{d}(xᵢ), (11)

an onlooker bee colony is chosen according to Formula (11) in a roulette form, and the first SN onlooker bees with a maximal fitness function are chosen to create new food source information.

Step 4, setting a cycle number as limit times, if the food source information is not updated in the limit times of cycles, transforming the employed bees into scout bees, and reinitializing the individuals by using Formula (7) in Step 1;

Step 5, when the iteration number reaches a set value, or after a mean square error value reaches the accuracy of 1e-4, extracting the connection weight ω and threshold b of the extreme learning machine from best individuals, and verifying by using a test set.

The present invention has the following advantageous technical effects:

with the method provided by the present invention, the defect of worse results obtained when the traditional extreme learning machine is applied to classification and regression is overcome in a better way, and the method has higher robustness with respect to the traditional extreme learning machine and SaE-ELM algorithms, and effectively improves the results of classification and regression.

### BRIEF DESCRIPTION OF THE DRAWINGS

FIG. 1 is a flowchart of the present invention.

### DETAILED DESCRIPTION OF PARTICULAR EMBODIMENTS OF THE INVENTION

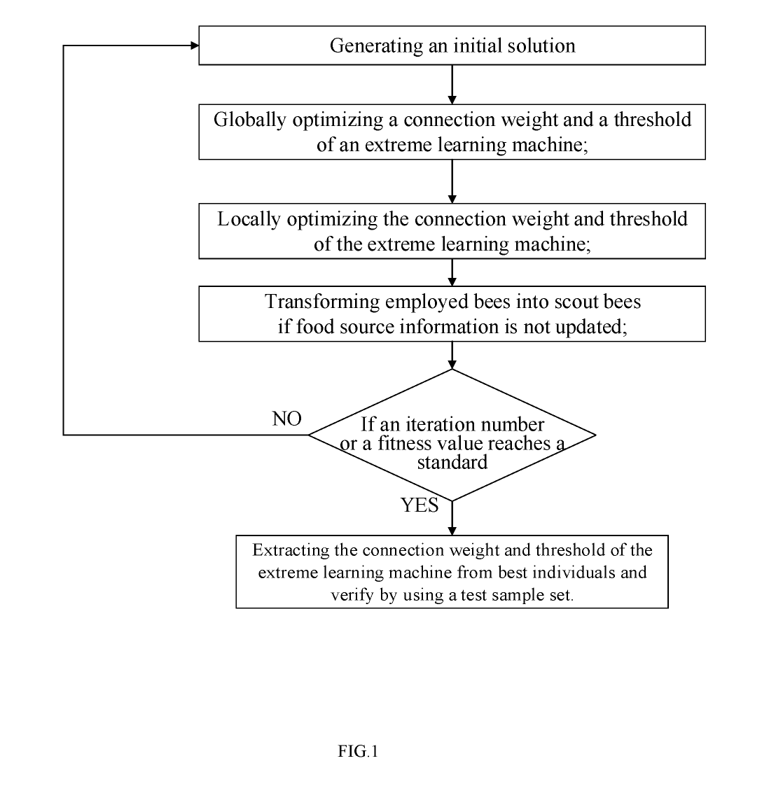

FIG. 1 is a flowchart of the present invention. As shown in FIG. 1, the improved extreme learning machine method based on the artificial bee colony optimization has a process as follows:

given a training sample set (xᵢ,yᵢ) (i=1, 2, . . . , N), xᵢ∈R^{d}, yᵢ∈R^{m}, with an activation function of g( ), and the number of hidden nodes of L;

Step 1: optimize a connection weight ω and a threshold b of an extreme learning machine by using an improved artificial bee colony algorithm, and generate an initial solution for SN individuals according to Formula (7) below:

x_{i,j}=xⱼ^{min}+rand[0,1](xⱼ^{max}−xⱼ^{min}) (7)

Therein, each individual is encoded in a manner as shown below:

θ_{G}=[ω_{l,G}^{T}, . . . ,ω_{L,G}^{T},b_{l,G}, . . . ,b_{L,G}]

According to the extreme learning machine algorithm, during encoding, ωⱼ (j=1, . . . , L) is a D-dimensional vector, with each dimension being a random number ranging from −1 to 1, bⱼ is a random number ranging from 0 to 1, and G indicates an iteration number for a bee colony.

Step 2: combine a differential evolution operator DE/rand-to-best/1 in a differential evolution (DE) algorithm with an employed bee searching formula based on the original artificial bee colony optimization algorithm, and globally optimize the connection weight ω and threshold b of the extreme learning machine by using the improved Formula (8).

v_{i,j}=x_{i,j}+rand[−1,1](x_{best,j}−x_{k,j}+x_{l,j}−x_{m,j}) (8)

Therein, x_{best, j} stands for a currently best individual in the bee colony, x_{k, j}, x_{l, j} and x_{m, j} are another three different individuals chosen randomly other than the current individual, i.e, i≠k≠l≠m; whenever the employed bees reach a new position, we verify a training sample set by means of the position information, i.e. the connection weight ω and threshold b of the extreme learning machine, and a fitness value is obtained, and if the fitness value is higher, new position information is used to substitute old position information.

Step 3: introduce a clone-increase operator in an immune clone algorithm into the artificial bee colony algorithm based on the original artificial bee colony optimization algorithm, and locally optimize the connection weight and threshold b of the extreme learning machine by using the improved formula.

First, an onlooker bee is cloned according to fitness thereof, which is in direct proportion to a cloning number as follows:

$${N}_{i} = int [ SN \times fitness ( {x}_{i} ) \text{/} {\sum }_{i = 1}^{SN} fitness ( {x}_{i} ) ] \qquad ( 9 )$$

In formula (9), N, indicates the cloning number of the i^{th} onlooker bee, SN indicates the total number of the individuals, and fitness (xᵢ) indicates a fitness value of the i^{th} following bee.

Second, for a clonally increased colony, the onlooker bees with a choice probability being more than a random number ranging from 0 to 1 are chosen and optimized according to a fitness probability calculation formula (6), i.e. the onlooker bees with higher fitness have higher change rate, and the optimization manner is the same as Formula (8).

After the position information of the onlooker bees is changed, a food source with higher fitness is chosen according to a choice probability formula by means of a concentration probability and the fitness probability of the colony and new position information is created, where the new position information screened is the same as the position information before expansion in number, Therein, the fitness probability calculation formula is the same as Formula (6), and the concentration probability and choice probability are as shown in Formula (10) to Formula (11).

A concentration probability calculation formula is as follows:

$$\{ \begin{matrix}{P}_{d} ( {x}_{i} ) = \frac{1}{SN} ( 1 - \frac{HN}{SN} ) & if \frac{{N}_{i}}{SN} > T \\ {P}_{d} ( {x}_{i} ) = \frac{1}{SN} ( 1 + \frac{HN}{SN} \times \frac{HN}{SN - HN} ) & if \frac{{N}_{i}}{SN} \leq T\end{matrix} , \qquad ( 10 )$$

In Formula (10), Nᵢ indicates the number of onlooker bees having a fitness value approximate to the i^{th} onlooker bee,

$$\frac{{N}_{i}}{SN}$$

indicates a quantitative proportion of these onlooker bees approximate in fitness in the colony, T is a concentration threshold, and HN indicates the number of onlooker bees having the concentration of more than T.

The choice probability calculation formula is as follows:

P_{choose}(xᵢ)=αPᵢ(xᵢ)+(1−α)P_{d}(xᵢ) (11)

An onlooker bee colony is chosen according to the above choice probability formula in a roulette form, and the first SN onlooker bees with the maximal fitness function are chosen to create new food source information.

Step 4: if the food source information is not updated within the limit times of cycles given as an initial condition, transform the employed bees into scout bees, and reinitialize the individuals by using Formula (7) in Step 1. In this embodiment, the limit number of times is chosen as 10.

Step 5: when the iteration number reaches a set value, or after a mean square error value reaches the accuracy of 1e-4, extract the connection weight ω and threshold b of the extreme learning machine from best individuals, and verify by using a test set.

The three embodiments below are used to prove that compared with the prior art, the technical solution of the present invention pertains to a superior technical solution.

### Embodiment 1: Simulation Experiment of Sin C Function

An expression formula of the Sin C function is as follows:

$$y ( x ) = \{ \begin{matrix}sin x \text{/} x , & x \neq 0 \\ 1 , & x = 0\end{matrix}$$

A data generation method is as follows: generating 5000 data x uniformly distributed within [−10, 10], calculating to obtain 5000 data sets {xᵢ,f(xᵢ)}, i=1, . . . 5000, and generating 5000 noises ε uniformly distributed within [−0.2, 0.2] again; letting a training sample set as {xᵢ,f(xᵢ)+εᵢ}, i=1, . . . 5000, generating another group of 5000 data sets={yᵢ,f(yᵢ)},i=1, . . . , 5000 as a test set. The number of hidden nodes of four algorithms is gradually increased for function fitting, and ABC-ELM and DECABC-ELM algorithms are same in parameter setting. The results are as shown in Table 1.

TABLE 1
Comparison of fitting results of SinC function

| Number | | | | | | |
|---|---|---|---|---|---|---|
| of | Perfor- | SaE- | PSO- | DEPSO- | ABC- | DECABC- |
| Nodes | mance | ELM | ELM | ELM | ELM | ELM |
| 1 | RMSE | 0.3558 | 0.3561 | 0.3561 | 0.3561 | 0.3561 |
| | Std. Dev. | 0.0007 | 0 | 0 | 0 | 0.0001 |
| 2 | RMSE | 0.1613 | 0.1694 | 0.2011 | 0.2356 | 0.1552 |
| | Std. Dev. | 0.0175 | 0.0270 | 0.0782 | 0.1000 | 0.0170 |
| 3 | RMSE | 0.1571 | 0.1524 | 0.1503 | 0.1871 | 0.1447 |
| | Std. Dev. | 0.0195 | 0.0181 | 0.0416 | 0.0463 | 0.0152 |
| 4 | RMSE | 0.1470 | 0.1330 | 0.1276 | 0.1564 | 0.1370 |
| | Std. Dev. | 0.0395 | 0.0390 | 0.0291 | 0.0336 | 0.0339 |
| 5 | RMSE | 0.1332 | 0.1314 | 0.1226 | 0.1306 | 0.1005 |
| | Std. Dev. | 0.0274 | 0.0325 | 0.0230 | 0.0228 | 0.0316 |
| 6 | RMSE | 0.0948 | 0.1285 | 0.1108 | 0.1112 | 0.0700 |
| | Std. Dev. | 0.0317 | 0.0269 | 0.0210 | 0.0245 | 0.0209 |
| 7 | RMSE | 0.0362 | 0.0783 | 0.0734 | 0.0870 | 0.0345 |
| | Std. Dev. | 0.0165 | 0.0297 | 0.0330 | 0.0419 | 0.0159 |
| 8 | RMSE | 0.0291 | 0.0523 | 0.0370 | 0.0497 | 0.0266 |
| | Std. Dev. | 0.0082 | 0.0321 | 0.0180 | 0.0297 | 0.0094 |
| 9 | RMSE | 0.0151 | 0.0229 | 0.0191 | 0.0329 | 0.0129 |
| | Std. Dev. | 0.0067 | 0.0050 | 0.0053 | 0.0082 | 0.0069 |
| 10 | RMSE | 0.0119 | 0.0191 | 0.0170 | 0.0208 | 0.0086 |
| | Std. Dev. | 0.0068 | 0.0084 | 0.0059 | 0.0065 | 0.0050 |
| 11 | RMSE | 0.0143 | 0.0141 | 0.0124 | 0.0238 | 0.0093 |
| | Std. Dev. | 0.0025 | 0.0036 | 0.0024 | 0.0056 | 0.0030 |

As can be seen from Table 1, as the hidden nodes increase, the mean test error and standard deviation gradually decrease, and when there are too many hidden nodes, overfitting may occur. Due to the defects of easy coverage to a local best solution and the like, ABC-ELM still has a worse effect when the number of nodes is large. In most cases, with the same number of the hidden nodes, DECABC-ELM is lower in mean test error and standard deviation.

In embodiment 1, the specific steps are as follows:

Step 1: generate an initial solution for SN individuals, where each individual is encoded in a manner as shown below

θ_{G}=[ω_{l,G}^{T}, . . . ,ω_{L,G}^{T},b_{l,G}, . . . ,b_{L,G}]

and during encoding, ωⱼ (j=1, . . . , L) is a D-dimensional vector, with each dimension being a random number ranging from −1 to 1, bⱼ is a random number ranging from 0 to 1, and G indicates an iteration number for a bee colony. A method for generating the initial solution is based on the formula below:

x_{i,j}=xⱼ^{min}+rand[0,1](xⱼ^{max}−xⱼ^{min});

that is, x_{i, j} stands for any one value from θ individuals, and an initial ωₗ^{T} is generated by using the formula. After the initialization is completed, the fitness value is calculated for each individual, and the fitness value here is negatively correlated to the mean square error.

Step 2: optimize each individual by using the improved employed bee searching formula, where an optimization formula is as shown below:

wherein x_{best, j} stands for the value of the j^{th} dimension of a best individual in the current bee colony, x_{k, j}, x_{l, j} and x_{m, j} are the values of the j^{th} dimensions of another three different individuals chosen randomly other than the current individual, i.e. i≠k≠l≠m. Since each individual θ includes the connection weight ω and threshold b of ELM, we use the contents of the individual θ before and after change to construct an ELM network, and a result obtained from ELM and a result of the Sin C function are used to solve the mean square error. If the mean square error of the changed individual is smaller, the fitness value is larger, and the new position information is used to substitute the old position information.

Step 3: clonally increase each individual θ, and choose the corresponding individual based on a certain probability for changing the position information. First, an onlooker bee is cloned according to fitness thereof, which is in direct proportion to a cloning number as follows:

$${N}_{i} = int [ SN \times fitness ( {x}_{i} ) \text{/} {\sum }_{i = 1}^{SN} fitness ( {x}_{i} ) ] ;$$

wherein Nᵢ indicates the cloning number of the i^{th} onlooker bee, SN indicates the total number of the individuals, and fitness(xᵢ) indicates a fitness value of the i^{th} following bee.

An optimization operation is performed on the clonally increased colony according to the probability, with an optimization formula the same as that in Step 2 above, and a probability formula is as follows:

$${P}_{i} = fitness ( {x}_{i} ) \text{/} {\sum }_{j = 1}^{SN} fitness ( {x}_{j} )$$

wherein fitness(n) indicates a fitness value of the i^{th} onlooker bee. Pᵢ stands for the probability of choosing the i^{th} onlooker bee for updating.

After position information of the cloned onlooker bees is changed, the fitness value of each individual is calculated, i.e., the connection weight ω and threshold b of ELM included in each individual θ are extracted to subsequently construct an ELM network, an input value of the Sin C function is substituted into ELM to solve a result which is used to solve the mean square error together with a correct result of the function, and fitness information is calculated.

In the colony subjected to clonal variation, a food source with higher fitness is chosen based on the concentration and fitness of the colony to create new position information, where the new position information screened and the position information before increase are same in number. Therein, the fitness probability is the same as the probability formula above, and the concentration probability and the choice probability are as shown below:

A concentration probability calculation formula is as follows:

$$\{ \begin{matrix}{P}_{d} ( {x}_{i} ) = \frac{1}{SN} ( 1 - \frac{HN}{SN} ) & if \frac{{N}_{i}}{SN} > T \\ {P}_{d} ( {x}_{i} ) = \frac{1}{SN} ( 1 + \frac{HN}{SN} \times \frac{HN}{SN - HN} ) & if \frac{{N}_{i}}{SN} \leq T\end{matrix}$$

wherein Nᵢ indicates the number of onlooker bees having a fitness value approximate to the i^{th} onlooker bee,

$$\frac{{N}_{i}}{SN}$$

indicates a quantitative proportion of these onlooker bees approximate in fitness in the colony, T is a concentration threshold, and HN indicates the number of onlooker bees having the concentration of more than T.

The choice probability calculation formula is as follows:

P_{choose}(xᵢ)=αPᵢ(xᵢ)+(1−α)P_{d}(xᵢ)

An onlooker bee colony is chosen according to the above choice probability formula in a roulette form, and the first SN onlooker bees with a maximal fitness function are chosen to create new food source information.

If the food source information is not updated within a certain time, the employed bees are transformed into scout bees, and the individuals are reinitialized by using the formula in Step 1.

After a certain times of iterations, we obtain the connection weight ω and threshold b of ELM included in the best individual θ to construct the ELM network, a test set reserved by the Sin C function is used to test the ELM, and an obtained result of ELM and the result of the Sin C function are used to solve the mean square error. After the whole experiment is performed multiple times, the mean square errors are averaged, and the standard deviation among all the mean square errors is calculated, and the comparison with other algorithms is made. The comparison results are as shown in Table 1.

### Embodiment 2: Simulation Experiment of Regression Data Set

4 real-world regression data sets from the Machine Learning Library of University of California Irvine were used to compare the performances of the four algorithms. The names of the data sets are Auto MPG (MPG), Computer Hardware (CPU), Housing and Servo respectively. In this experiment, the data in the data sets are randomly divided into a training sample set and a test sample set, with 70% as the training sample set and 30% remained as the test sample set. To reduce the impacts from large variations of all the variables, we perform normalizing on the data before the algorithm is executed, i.e., an input variable normalized to [−1, 1], and an output variable normalized to [0, 1]. Across all the experiments, the hidden nodes gradually increase, and the experiment results having the mean best RMSE are recorded into Tables 2 to Table 5.

TABLE 2
Comparison of fitting results of Auto MPG

| | Test Set | | Training | Number of |
|---|---|---|---|---|
| Algorithm Name | RMSE | Std. Dev. | Tie (s) | Hidden Nodes |
| SaE-ELM | 0.0726 | 0.0019 | 6.6517 | 20 |
| PSO-ELM | 0.0739 | 0.0033 | 4.7803 | 20 |
| DEPSO-ELM | 0.0741 | 0.0043 | 3.7441 | 17 |
| ABC-ELM | 0.0745 | 0.0039 | 5.2760 | 21 |
| DECABC-ELM | 0.0702 | 0.0032 | 5.2039 | 19 |

TABLE 3
Comparison of fitting results of Computer Hardware

| | Test Set | | Training | Number of |
|---|---|---|---|---|
| Algorithm Name | RMSE | Std. Dev. | Time (s) | Hidden Nodes |
| SaE-ELM | 0.0412 | 0.0148 | 4.2279 | 15 |
| PSO-ELM | 0.0386 | 0.0116 | 2.4960 | 13 |
| DEPSO-ELM | 0.0461 | 0.0120 | 2.0137 | 11 |
| ABC-ELM | 0.0516 | 0.0248 | 1.8319 | 11 |
| DECABC-ELM | 0.0259 | 0.0170 | 2.4466 | 10 |

TABLE 4
Comparison of fitting results of Housing

| | Test Set | | Training | Number of |
|---|---|---|---|---|
| Algorithm Name | RMSE | Std. Dev. | Time (s) | Hidden Nodes |
| SaE-ELM | 0.0720 | 0.0049 | 42.4382 | 69 |
| PSO-ELM | 0.0642 | 0.0072 | 28.5984 | 67 |
| DEPSO-ELM | 0.0656 | 0.0064 | 26.7162 | 70 |
| ABC-ELM | 0.0748 | 0.0050 | 25.4063 | 68 |
| DECABC-ELM | 0.0567 | 0.0046 | 30.8024 | 66 |

TABLE 5
Comparison of fitting results of Servo

| | Test Set | | Training | Number of |
|---|---|---|---|---|
| Algorithm Name | RMSE | Std. Dev. | Time (s) | Hidden Nodes |
| SaE-ELM | 0.1785 | 0.0094 | 6.4484 | 30 |
| PSO-ELM | 0.1877 | 0.0166 | 3.1621 | 22 |
| DEPSO-ELM | 0.1959 | 0.0090 | 3.1918 | 25 |
| ABC-ELM | 0.1958 | 0.0136 | 3.9710 | 30 |
| DECABC-ELM | 0.1740 | 0.0075 | 4.0030 | 26 |

As can be seen from the tables, DECABC-ELM obtains the minimal RMSE among all the data set fitting experiments, however, DECABC-ELM has the standard deviation worse than those of other algorithms in Auto MPG and Computer Hardware, that is, its stability needs to be improved. From the view of training time and number of hidden nodes, PSO-ELM and DEPSO-ELM have higher convergence rate and less number of used hidden nodes, but with the accuracy worse than that of DECABC-ELM. Based on the overall consideration, DECABC-ELM, i.e. the algorithm as described in the present invention, has a superior performance.

The specific steps of Embodiment 2 are the same as that in Embodiment 1.

### Embodiment 3: Simulation Experiment of Classification Data Sets

The Machine Learning Library of the University of California Irvine was used. The names of the four real-world classification sets are Blood Transfusion Service Center (Blood), E coli, Iris and Wine respectively. Like that in the classification data sets, 70% of the experiment data is taken as the training sample set, 30% is taken as the testing sample set, and the input variables of the data set are normalized to [−1,1]. In the experiments, the hidden nodes gradually increase, and the experiment results having the best classification rate are recorded into Tables 6 to Table 9.

TABLE 6
Comparison of classification results of Blood

| | Test Set | | Training | Number of |
|---|---|---|---|---|
| Algorithm Name | Accuracy | Std. Dev. | Time (s) | Hidden Nodes |
| SaE-ELM | 77.2345% | 0.0063 | 8.2419 | 14 |
| PSO-ELM | 77.8610% | 0.0082 | 5.0326 | 8 |
| DEPSO-ELM | 77.9506% | 0.0085 | 4.8907 | 9 |
| ABC-ELM | 77.4200% | 0.0127 | 5.8219 | 10 |
| DECABC-ELM | 79.7323% | 0.0152 | 5.7354 | 9 |

TABLE 7
Comparison of classification results of Ecoli

| | Test Set | | Training | Number of |
|---|---|---|---|---|
| Algorithm Name | Accuracy | Std. Dev. | Time (s) | Hidden Nodes |
| SaE-ELM | 91.0143% | 0.0170 | 10.4231 | 30 |
| PSO-ELM | 91.0494% | 0.0316 | 3.0225 | 10 |
| DEPSO-ELM | 90.8713% | 0.0379 | 2.6734 | 10 |
| ABC-ELM | 91.0319% | 0.0254 | 2.7255 | 10 |
| DECABC-ELM | 93.2137% | 0.0169 | 3.4627 | 10 |

TABLE 8
Comparison of classification results of Iris

| | Test Set | | Training | Number of |
|---|---|---|---|---|
| Algorithm Name | Accuracy | Std. Dev. | Time (s) | Hidden Nodes |
| SaE-ELM | 99.1076% | 0.0192 | 5.3660 | 24 |
| PSO-ELM | 99.5548% | 0.0144 | 2.7552 | 19 |
| DEPSO-ELM | 99.3171% | 0.0235 | 2.4660 | 19 |
| ABC-ELM | 99.5387% | 0.0159 | 1.7334 | 15 |
| DECABC-ELM | 99.5692% | 0.0100 | 2.5603 | 15 |

TABLE 9
Comparison of classification results of Wine

| | Test Set | | Training | Number of |
|---|---|---|---|---|
| Algorithm Name | Accuracy | Std. Dev. | Time (s) | Hidden Nodes |
| SaE-ELM | 91.1442% | 0.0259 | 3.0022 | 11 |
| PSO-ELM | 91.1292% | 0.0191 | 1.8908 | 10 |
| DEPSO-ELM | 91.5565% | 0.0273 | 1.6432 | 10 |
| ABC-ELM | 91.1292% | 0.0191 | 1.5364 | 9 |
| DECABC-ELM | 92.2662% | 0.0210 | 2.0199 | 7 |

As shown in the tables, DECABC-ELM has highest classification accuracy among the four classification data sets. However, DECABC-ELM is still dissatisfactory in terms of stability. The used time of DECABC-ELM is longer compared with those of PSO-ELM, DEPSO-ELM, and ABC-ELM, but is shorter than that of SaE-ELM. Compared with other algorithms, DECABC-ELM may achieve higher classification accuracy with fewer hidden nodes. In view of the considerations above, DECABC-ELM, i.e., the algorithm as described in the present invention, has a superior performance.

The specific steps of Embodiment 3 are the same as that in Embodiment 1.

The description above only provides preferred embodiments of the present invention, and the present invention is not limited to the embodiments above. It can be understood that other improvements and variations directly derived or though up of by those skilled in the art without departing from the spirit and concept of the present invention shall be construed to fall within the protection scope of the present invention.

What is claimed is:

1. An improved extreme learning machine method based on artificial bee colony optimization, comprising the following steps:
given a training sample set (xᵢ,yᵢ) (i=1, 2, . . . , N), xᵢεR^{d}, yᵢεR^{m}, with an activation function of g( ), and a number of hidden node of L;
step 1: generating an initial solution for SN individuals as follows:
x_{i,j}=xⱼ^{min}+rand[0,1](xⱼ^{max}−xⱼ^{min}), (7)
wherein each individual is encoded in a manner as shown below:
θ_{G}=[ω_{l,G}^{T}, . . . ,ω_{L,G}^{T},b_{l,G}, . . . ,b_{L,G}];
wherein during an encoding, ωⱼ (j=1, . . . , L) is a D-dimensional vector, with each dimension being a random number ranging from −1 to 1, bⱼ is a random number ranging from 0 to 1, and G indicates an iteration number for a bee colony;
step 2: globally optimizing a connection weight ω and a threshold b for an extreme learning machine as follows:
v_{i,j}=x_{i,j}+rand[−1,1](x_{best,j}−x_{k,j}+x_{l,j}−x_{m,j}), (8)
wherein in the Formula (8), x_{best, j} stands for a currently best individual in the bee colony, x_{k, j}, x_{l, j} and x_{m, j} are another three different individuals chosen randomly except the current individual, thus, i≠k≠l≠m; whenever employed bees reach a new position, a training sample set is verified by means of the connection weight ω and threshold b of the extreme learning machine and a fitness value is obtained, and under the condition of a high fitness value, a new position information is used to substitute an old position information;
step 3: locally optimizing the connection weight ω and threshold b of the extreme learning machine;
firstly, an onlooker bee is cloned according to a fitness of the onlooker bee, a cloning number is in direct proportion to the fitness as follows:
$${N}_{i} = int [ SN \times fitness ( {x}_{i} ) \text{/} {\sum }_{i = 1}^{SN} fitness ( {x}_{i} ) ] , \qquad ( 9 )$$
wherein in formula (9), Nᵢ indicates a cloning number of a i^{th} onlooker bee, SN indicates a total number of the individuals, and fitness(xᵢ) indicates a fitness value of the i^{th} following bee;
secondly, for a colony increased by clone, the onlooker bees with a choice probability being more than a random number ranging from 0 to 1 are optimized according to a fitness probability calculation formula in the same manner of Formula (8);
after the position information of the onlooker bees is changed, a food source is chosen with a choice probability calculation formula by means of a concentration probability and the fitness probability of the colony, and the new position information is created; and the number of the new position information is the same as the number of the position information before increasing;
the fitness probability calculation formula is as follows:
$${P}_{i} = fitness ( {x}_{i} ) \text{/} {\sum }_{j = 1}^{SN} fitness ( {x}_{j} ) , \qquad ( 6 )$$
a concentration probability calculation formula is as follows:
$$\{ \begin{matrix}{P}_{d} ( {x}_{i} ) = \frac{1}{SN} ( 1 - \frac{HN}{SN} ) & if \frac{{N}_{i}}{SN} > T \\ {P}_{d} ( {x}_{i} ) = \frac{1}{SN} ( 1 + \frac{HN}{SN} \times \frac{HN}{SN - HN} ) & if \frac{{N}_{i}}{SN} \leq T\end{matrix} , \qquad ( 10 )$$
wherein in Formula (10), Nᵢ indicates the number of the onlooker bees having a fitness value approximate to the i^{th} onlooker bee,
$$\frac{{N}_{i}}{SN}$$
indicates a quantitative proportion of the onlooker bees approximate in fitness in the colony, T is a concentration threshold, and HN indicates the number of the onlooker bees having a concentration greater than T;
the choice probability calculation formula is as follows:
P_{choose}(xᵢ)=αPᵢ(xᵢ)+(1−α)P_{d}(xᵢ), (11)
an onlooker bee colony is chosen according to Formula (11) in a roulette form, and the first SN onlooker bees with a maximal fitness function are chosen to create a new food source information.
step 4: setting a cycle number as a limit times, under the condition that the food source information is not updated in the limit times of cycles, transforming the employed bees into scout bees, and reinitializing the individuals by using Formula (7) in Step 1; step 5: under the condition that the iteration number reaches a set value or a mean square error value reaches an accuracy of 1e-4, extracting the connection weight ω and threshold b of the extreme learning machine from the best individuals, and verifying by using a test set.
